(19) United States
(12) Patent Application Publication
(10) Pub. No.: US 2023/0292087 A1
(43) Pub. Date: Sep. 14, 2023

(54) PROXIMITY DETERMINATION FOR MOBILE DEVICES

(71) Applicant: Whitespace, Ltd., Alexandria, VA (US)

(72) Inventors: Jacqueline Barbieri, Alexandria, VA (US); Jared Campbell, Alexandria, VA (US); Forrest Crawford, Alexandria, VA (US); Patrick Kenney, Alexandria, VA (US); Thomas Valleau, Alexandria, VA (US)

(21) Appl. No.: 17/692,039

(22) Filed: Mar. 10, 2022

(51) Int. Cl. H04W 4/02; H04W 4/029

(52) U.S. Cl. CPC H04W 4/023; H04W 4/029

(57) ABSTRACT

An apparatus and method that determine a proximity between a first mobile device and a second mobile device, receive anonymized location information associated with the first mobile device and the second mobile device, respectively, select a portion of the anonymized location information that is within a first predetermined distance for each of the first mobile device and the second mobile device, respectively, transform the selected portion of the anonymized location information into approximate location probability densities for each of the first mobile device and the second mobile device, respectively, select pairs of anonymized location information from the approximate location probability densities, associated with the first and second mobile devices, respectively, and determine a distribution of distances between the selected pairs of anonymized location information associated with the first and second mobile devices, respectively, and determine a density of distances from the determined distribution of distances.

### CROSS-REFERENCE TO RELATED APPLICATION

NA

### BACKGROUND OF THE DISCLOSURE

### 1. Field of the Disclosure

The disclosure relates in general to proximity determination, and more particularly, to proximity determination for mobile devices.

### 2. Background Art

“Mobility metrics” is the process by which mobile device data, such as cell phone data, is aggregated to obtain analytics related to mobility, while protecting individual privacy by converting this cell phone data into mobility metrics or anonymized location information. This process converts data from locations associated with mobile devices, such as trip start points, trip end points, stationary points, etc. into anonymized location information, and aggregates this anonymized location information over time. Mobility metrics can be produced hourly, daily, monthly, yearly, etc. for a particular area(s) and a particular time period(s).

Anonymized location information can be used for a variety of purposes. For example, anonymized location information can be used to track a number of vehicles traversing a particular road at a particular time to help policymakers determine if the particular road is adequate to service the number of vehicles traversing that particular road at that particular time, to track a number of persons attending a public event (e.g., a protest in a particular city at a particular time) to help policymakers determine if sanitation services were adequate for that public event, to track a number of persons traveling from one part of a country to another part of the country for a particular holiday to help policymakers determine if such travel can be streamlined, track a number of persons moving to a particular city to help policymakers determine if city services are adequate to service these new persons, and any other purpose in which it would be beneficial to track anonymized location information.

### SUMMARY OF THE DISCLOSURE

The disclosure is directed to a method for determining a proximity between a first mobile device and a second mobile device. The method comprises receiving, by a network interface and from a mobility metrics server, anonymized location information associated with the first mobile device and the second mobile device, respectively. The method further comprises selecting a portion of the anonymized location information that is within a first predetermined distance for each of the first mobile device and the second mobile device, respectively. The method even further comprises transforming the selected portion of the anonymized location information into approximate location probability densities for each of the first mobile device and the second mobile device, respectively. The method yet further comprises selecting pairs of anonymized location information from the approximate location probability densities, associated with the first and second mobile devices, respectively. The method even yet further comprises determining a distribution of distances between the selected pairs of anonymized location information associated with the first and second mobile devices, respectively. The method also comprises determining a density of distances from the determined distribution of distances between the selected pairs of anonymized location information associated with the first and second mobile devices, respectively. The method yet also comprises determining probabilities that the first and second mobile devices are within a second predetermined distance from each other, the probabilities based on the density of distances.

In at least one configuration of the method, the first predetermined distance is approximately one (1) meter or three (3) feet and the second predetermined distance is approximately two (2) meters or six (6) feet.

In at least one configuration of the method, the selecting selects the portion of the anonymized location information when the first and second mobile devices were stationary and within the predetermined distance to one another at a same time.

In at least one configuration of the method, the method further comprises excluding selection of the portion of the anonymized location information if the first and second mobile devices are within a buffered polygon.

In at least one configuration of the method, the distribution of distances is determined analytically.

In at least one configuration of the method, the method further comprises performing a mathematical correction on the distances between the first and second mobile devices to account for a curvature of the Earth.

In at least one configuration of the method, the method further comprises adding the probabilities that the first and second mobile devices are within the second predetermined distance from each other to determine a rate of contact between the first and second mobile devices per a time interval within a region.

In at least one configuration of the method, the method further comprises predicting a pandemic spread based on the determined probabilities that the first and second mobile devices are within the second predetermined distance from each other.

In at least one configuration of the method, the method further comprises performing a Gaussian approximation for the distribution of distances between the selected pairs of anonymized location information associated with the first and second mobile devices.

In at least one configuration of the method, wherein the first and second mobile devices are at least one of a smartphone, a tablet computer, vehicle, an Internet-of-Things (IoT) device, and a smart watch.

The disclosure is further directed to an apparatus comprising a network interface, an anonymized location information analyzer module, a location densities analyzer module, a distribution of distances module, and a density of distance analyzer module. The network interface receives anonymized location information associated with the first mobile device and the second mobile device, respectively. The anonymized location information analyzer module selects a portion of the anonymized location information that is within a first predetermined distance for each of the first mobile device and the second mobile device, respectively. The location densities analyzer module transforms the selected portion of the anonymized location information into approximate location probability densities for each of the first mobile device and the second mobile device, respectively. The distribution of distances module selects pairs of anonymized location information from the approximate location probability densities, associated with the first and second mobile devices, respectively, and determines a distribution of distances between the selected pairs of anonymized location information associated with the first and second mobile devices, respectively. The density of distance analyzer module determines a density of distances from the determined distribution of distances between the selected pairs of anonymized location information associated with the first and second mobile devices, respectively, and determines probabilities that the first and second mobile devices are within a second predetermined distance from each other, the probabilities based on the density of distances.

In at least one configuration of the apparatus, the first predetermined distance is approximately one (1) meter or three (3) feet and the second predetermined distance is approximately two (2) meters or six (6) feet.

In at least one configuration of the apparatus, the distribution of distances module selects the portion of the anonymized location information when the first and second mobile devices were stationary and within the predetermined distance to one another at a same time.

In at least one configuration of the apparatus, the apparatus excludes selection of the portion of the anonymized location information if the first and second mobile devices are within a buffered polygon.

In at least one configuration of the apparatus, the distribution of distances is determined analytically.

In at least one configuration of the apparatus, the apparatus performs a mathematical correction on the distances between the first and second mobile devices to account for a curvature of the Earth.

In at least one configuration of the apparatus, the apparatus further adds the probabilities that the first and second mobile devices are within the second predetermined distance from each other to determine a rate of contact between the first and second mobile devices per a time interval within a region.

In at least one configuration of the apparatus, the apparatus further comprises a pandemic prediction module to predict a pandemic spread based on the determined probabilities that the first and second mobile devices are within the second predetermined distance from each other.

In at least one configuration of the apparatus, the apparatus further performs a Gaussian approximation for the distribution of distances between the selected pairs of anonymized location information associated with the first and second mobile devices.

In at least one configuration of the apparatus, the first and second mobile devices are at least one of a smartphone, a tablet computer, vehicle, an Internet-of-Things (IoT) device, and a smart watch.

### BRIEF DESCRIPTION OF THE DRAWINGS

The disclosure will now be described with reference to the drawings wherein:

FIG. 1 illustrates a schematic view of an example system including an example proximity detection apparatus, in accordance with at least one configuration disclosed herein;

FIG. 2 illustrates a detailed schematic view of an example proximity detection application shown in FIG. 1, in accordance with at least one configuration disclosed herein;

FIG. 3 illustrates contact rate for COVID-19 by town in Connecticut during Feb. 1-Jan. 31, 2021, in accordance with at least one configuration disclosed herein;

FIG. 4 illustrates contact rates, estimated SARS-CoV-2 infections, observed and estimated case counts, estimated cumulative incidence, as well as 95% uncertainty intervals for model estimates, for the five largest cities by population in Connecticut, in accordance with at least one configuration disclosed herein;

FIG. 5 illustrates contact rates, confirmed non-congregate COVID-19 case counts, and 95% uncertainty intervals for cases in five Connecticut towns where incidence patterns differed from those of the larger cities shown in FIG. 4, in accordance with at least one configuration disclosed herein;

FIG. 6 illustrates a screenshot that an interactive web application can display, in accordance with at least one configuration disclosed herein;

FIG. 7 illustrates mobility metrics published by Apple using the day-of-week median during Feb. 2-Feb. 29, 2020, as a baseline for Connecticut, in accordance with at least one configuration disclosed herein;

FIG. 8 illustrates mobility metrics published by Google using the day-of-week median from Jan. 3, 2020, to Feb. 6, 2020, as the baseline for Connecticut, in accordance with at least one configuration disclosed herein;

FIG. 9 illustrates mobility metrics published by Facebook with day-of-week mean during Feb. 2-Feb. 29, 2020 (excluding February 17) as the baseline for Connecticut, in accordance with at least one configuration disclosed herein;

FIG. 10 illustrates mobility data provided by Cuebiq with day-of-week median during Feb. 2-Feb. 29, 2020, as the baseline for Connecticut, in accordance with at least one configuration disclosed herein;

FIG. 11 illustrates shows Cuebiq's metric for “contact”, when two or more devices are within 50 feet of each other within five minutes, in accordance with at least one configuration disclosed herein;

FIG. 12 illustrates mobility metric provided by Descartes Labs with day-of-week median during Feb. 17-Mar. 7, 2020, as the baseline for Connecticut, in accordance with at least one configuration disclosed herein;

FIG. 13 illustrates a flowchart of an example method for determining a proximity between mobile devices, in accordance with at least one configuration disclosed herein; and

FIG. 14 illustrates an exemplary general-purpose computing device for use with the system shown in FIG. 1, in accordance with at least one configuration disclosed herein.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

It has come to be appreciated that typical proximity determination between any two mobile devices based on anonymized location information is not accurate enough for some utilizations of such proximity determinations. The proximity determination between mobile devices disclosed herein overcomes such a deficiency within the art by increasing an accuracy of such proximity determination between any two mobile devices to at least approximately (+−10%) two meters or approximately six (6) feet. Such an increase in accuracy of proximity determination allows for new uses of such increased accuracy information. As discussed in detail below, an example that utilizes such an increase in accuracy of proximity determination is a pandemic spread projection, with such pandemic spread projection having particular application to the current COVID-19 pandemic, but the disclosed increase in accuracy of proximity determination is not limited to the COVID-19 pandemic and can be utilized for any application that can benefit from the disclosed increase in accuracy of proximity determination. For example, the disclosed proximity detection can be used for law enforcement, advertising, crowd control, infrastructure usage monitoring, and any other usage that can benefit from the proximity determination disclosed herein, as discussed further below.

One of the uses of the contact metric is measuring the frequency of close interpersonal contact during the COVID-19 pandemic. While individual-level compliance with social distancing guidelines can be difficult to measure, researchers have proposed population-level mobility metrics based on mobile device geolocation data as a proxy measure for physical distancing and movement patterns during the COVID-19 pandemic. Investigators have characterized geographic and temporal changes in mobility metrics following non-pharmaceutical interventions like social distancing guidelines and stay-at-home mandates during the COVID-19 pandemic. Researchers have also studied the association between mobility metrics and COVID-19 cases or other proxy measures of transmission. Most mobility metrics measure aggregated movement patterns of individual mobile devices: time spent away from home, distance traveled, or density of devices appearing in an area during a given time interval. CDC reports mobility metrics from Google, Safegraph, and Cuebiq.

Typical mobility metrics might not capture simultaneous colocation of the mobile devices, do not measure contact within a two-meter distance associated with highest transmission risk (via direct contact or exposure to respiratory droplets), and might not take intrinsic mobile device spatial location error (horizontal uncertainty) into account. While typical mobility metrics can help policymakers understand the extent to which the public is in compliance with mandated movement restrictions, typical mobility metrics do not provide insight into the frequency of close interactions between individuals outside of the home: a key driver of disease transmission. Understanding where and when close contact events are occurring, where high-contact populations reside, and which regions are most connected via close contacts is critically important to leaders weighing decisions about when to lift or ease policies, or when it is safe to re-open businesses during the COVID-19 pandemic.

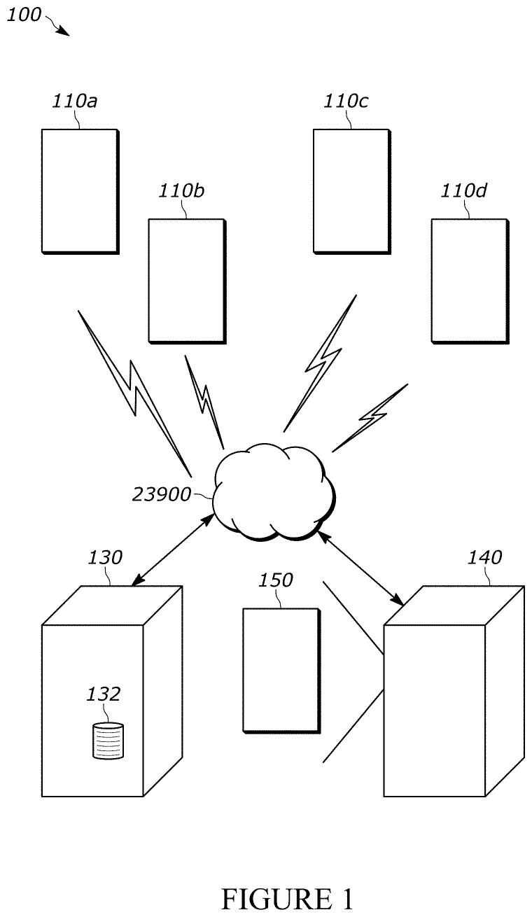

Referring now to the drawings and in particular to FIG. 1, a system 100 is illustrated that includes a plurality of Radio Frequency (RF) devices, such as mobile devices 110a-d. The mobile devices can include smartphones, tablet computers, vehicles (e.g., cars, trucks, or any other vehicle) smart watches, any type of Internet-of-Things (IoT) device, and any other smart devices that transmits location information while in use. Although only four of the plurality of mobile devices 110a-d are shown, one skilled in the art would understand that such is for simplicity of illustration and explanation, the system 100 is not limited to any number of mobile devices 110 and can include any number of mobile devices. The location information can be provided by a Global Navigation Satellite System (GNSS), such as Global Positioning System (GPS), Galileo, Global Navigation Satellite System (GLONASS), BeiDou, or any other satellite system that provides location information. The location information can be transmitted by each of the plurality of mobile devices 110a-d while in use. Such location information can further include proximity-based on Bluetooth, and geotagged locations of nearby WiFi hotspots and cell towers. For example, many applications or “apps” continuously track a location of the plurality of mobile devices 100 without owners of such devices even knowing that such location information is being collected and transmitted.

Alternatively, many users activate location services on the plurality of mobile devices 110a-d to transmit location information to set a time zone based on a current location, provide to provide routing and traffic information, tag photos with a location at which the photos were taken, provide geographically relevant alerts the users of the plurality of mobile devices 110a-d, share location information between the plurality of mobile devices 110a-d, customize search engine queries based on a current location of the plurality of mobile devices 110a-d, provide emergency call services (e.g., 911) based on a current location of the plurality of mobile devices 110a-d, etc. As such location information is valuable to companies or customers that can monetize this location information, such location information has become a valuable commodity. New apps providing new services for such location information are continuously being developed.

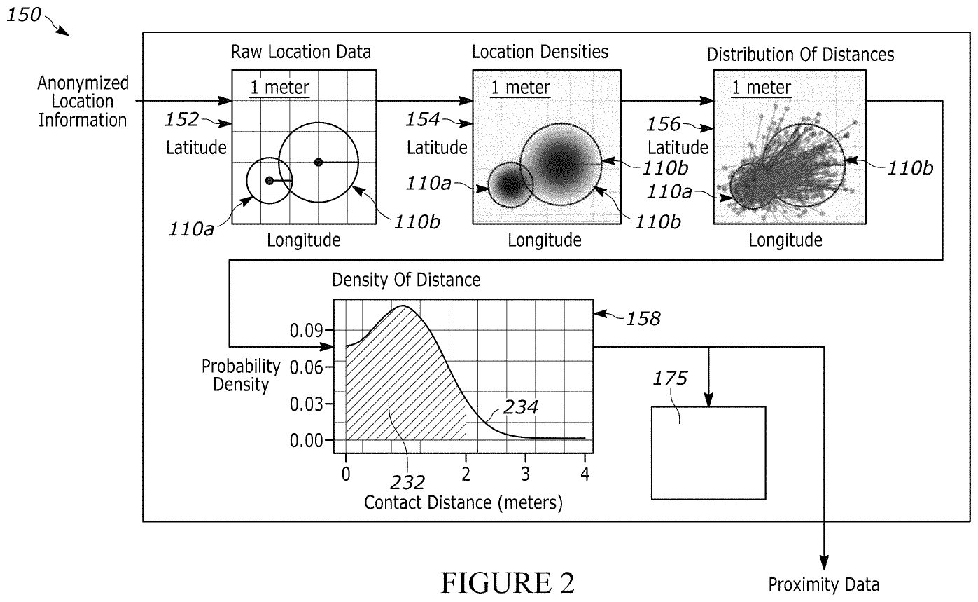

The system 100 further includes a network 23900, discussed in more detail below, that the plurality of mobile devices 110a-d are in communication with to transmit, among other types of information, the location information. The plurality of mobile devices 110a-d transmit the location information via this network 23900. The system 100 further includes a mobility metrics server 130 that is in communication with the network 23900 and collects the location information related to the plurality of mobile devices 110a-d, and stores this location information in an anonymous form in a location information database 132 therein. As discussed above, this anonymized location information can be provided (e.g., sold) to any of a number of customers that are able to utilize such anonymized location information, such as those discussed above. Various companies can implement the mobility metrics server 130 to provide mobility metrics, such as Camber Systems, Descartes Labs, Safegraph, Cuebiq, Unacast, Facebook, Google, Apple, or any other company that can host the mobility metrics server 130. In accordance with this disclosure, the system 100 can further include an apparatus, such as a proximity detection apparatus 140 (e.g., server, stand-along computer, etc.) that is in communication with the network 23900. The proximity detection apparatus 140 is in further communication with the mobility metrics server 130, such as via the network 23900, and can query for and receive anonymized location information from the mobility metrics server 130. The proximity detection apparatus 140 can execute a proximity detection application 150 (FIG. 2) that can determine proximity between any two of the plurality of mobile devices to at least approximately (+−10%) two meters or approximately six (6) feet, although other proximities are possible. The proximity detection apparatus 140 can, via the proximity detection application 150, determine a “Contact Metric”, implementing a method for determining a probability that any two of the mobile devices 110 are within a given distance of one another, the proximity detection apparatus 140 aggregating this probability across pairs of the mobile devices 110 within a given region, within a given time frame. The proximity detection apparatus 140 can be described as performing “statistical proximity determination”.

Now with reference to FIG. 2, the proximity detection application 150 will be discussed in detail. The proximity detection application 150 can include hardware modules and/or software modules, such as an anonymized location information analyzer module 152, a location densities analyzer module 154, a distribution of distances module 156, and a density of distance analyzer module 158. The anonymized location information analyzer module 152 receives the anonymized location information. Raw mobile device geolocation records contain unique device IDs that persist over time, GPS coordinates, expressed in latitude and longitude, date/time stamps, and GPS location error estimates, also called horizontal uncertainty, measured in distance, such as meters, such as for the mobile devices 110a, 110b. The anonymized location information analyzer module 152 analyzes this anonymized location information and selects a portion of the anonymized location information that is within a first predetermined distance, e.g., approximately (+−10%) one (1) meter or three (3) feet, for each of any two mobile devices, such as the mobile devices 110a, 110b, as shown within a left circle 202 and right circle 204, respectively. The anonymized location information analyzer module 152 performs such analysis for the mobile devices 110a, 110b when the mobile devices 110a, 110b were stationary and in proximity to one another at a same time. Although such analysis is described as being performed for mobile devices 110a, 110b, one skilled in the art would understand that such analysis can be performed for any two of the mobile devices 110a-d to determine their proximity to each other.

In at least one configuration, to avoid measuring spurious contact between mobile devices 110a-d that are not actually close to one another, or contact between people who live together associated with any of the mobile devices 110a-d, contacts that occur in some places are not recorded. For example, a buffered polygon derived from roadway center lines can be used to determine if a given contact event between the mobile devices 110a, 110b occurred within the buffered polygon, such as on a roadway. If so, then the contact record is excluded from determination of a contact rate within that region. Similarly, all contact events for the mobile devices 110a-d at their estimated primary dwell location are tagged and excluded when computing contact rates.

The location densities analyzer module 154 receives the selected portion of anonymized location information from the anonymized location information analyzer module 152. The location densities analyzer module 154 can then transform the selected portion of anonymized location information, including horizontal uncertainty estimates, from the anonymized location information into approximate location probability densities, as shown. The left and right circles 202, 204 are shown with a greatest concentration of anonymized location information at centers of the left and right circles 202, 204 where shading is darkest, the raw location data concentration decreasing as distance increases from the centers of the left and right circles 202, 204, shown as a decreasing gray surrounding the darkest centers.

The distribution of distances module 156 receives the location probability densities from the location densities analyzer module 154. The distribution of distances module 156 selects pairs of anonymized location information from the received approximate location probability densities, associated with the mobile devices 110a, 110b, respectively. The distribution of distances module 156 can then determines a distribution of distances from pairs of points drawn randomly from the location probability densities. The distribution of distances module 156 determines distances between these selected pairs of anonymized location information from the received location probability densities, associated with the mobile devices 110a, 110b, respectively.

Sampled distances are shown here for illustrative purposes in a more solid grey color, such as when locations between the mobile devices 110a, 110b are within six feet apart, and lighter gray, such as when locations between the mobile devices 110a, 110b are more than six feet apart. In at least one configuration, the distribution of distances module 156 can determine this distribution of distances analytically, although other methods of determining this distribution of distances are possible. In at least one configuration, a mathematical correction can be performed on the distances between the mobile devices 110a, 110b to account for a curvature of the Earth, that is the fact that the Earth is a sphere, not a plane.

The density of distance analyzer module 158 can receive the distribution of distances from the distribution of distances module 156. The density of distance analyzer module 158 can then determine a probability that the mobile devices 110a, 110b are within a second predetermined distance, e.g., approximately (+−10%) two (2) meters or six (6) feet, that is a density of distances from the received distribution of distances from the distribution of distances module 156. The density of distance analyzer module 158 can formulate an X/Y density of distances graph 230 showing a density of distance between the mobile devices 110a, 110b, by plotting the distribution of distances. The X axis is shown as representing a contact distance in meters, shown as ranging from 0 to 4 meters, but can include other distances without departing from the scope of this disclosure. The density of distance analyzer module 158 then determines a probability that the mobile devices 110a, 110b are within six feet, with shaded area 232 under density line 234 showing a probability that the mobile devices 110a, 110b are within six feet. Using these probability distributions representing true device locations of the mobile devices 110a, 110b, the probability that the mobile devices 110a, 110b are within six feet of each other is determined. That is, this is a proportion of times that pairs of random draws from the two distributions would produce locations of the mobile devices 110a, 110b within six feet of each other. This determination is performed analytically, without simulating random draws from the distributions. The result is a probability, between 0 and 1. Larger values equate to the mobile devices 110a, 110b being more likely to be within six feet of each other.

Thus, the anonymized location information analyzer module 152, the location densities analyzer module 154, the distribution of distances module 156, and the density of distance analyzer module 158 model true device locations as probability distributions centered at reported device GPS locations. The spread of these device location probability distributions is related to their horizontal uncertainty measurements. When the horizontal uncertainty is large, the probability distribution has greater spread, or variance.

Thus, the proximity detection application 150 implements a pipeline to extract points, radii, and movement to ascertain whether anonymized observations of different mobile devices 110 overlap spatially and temporally within given thresholds. Activities extracted from mobility data are analyzed based solely upon the knowledge that they pertain to pairs of distinct mobile devices 110 that are observed to be nearby one another. The pandemic prediction module 175 can aggregate potential contacts by day, as is information about infection risk by home location, and inter-regional networks of infection risk.

For each potential contact (PC) event, the proximity detection application 150 can calculate a pair probability of contact (PPC) which indicates the probability that a contact was close enough (e.g. within two meters) for infection transmission to occur if an individual were infectious. These metrics are then aggregated to the census block group or health district, and up to the county, state, and regional levels as indicators of infection risk by area. These metrics can be reported at the census block group level both for the census block where the potential contacts occurred (potential contacts per area), as well as by the “home” census block group for each of the mobile devices 110 involved in a potential contact event (potential contacts per resident). The anonymization and aggregation applied ensures that no individual mobile device's 110 activities can be identified, as the metrics are representative models of aggregate mobility data.

The pipeline produces networks of regions, linked through contact events for a given time period. This facilitates an understanding of how regions are linked through potential contact events. Just as with the potential contacts by area and potential contacts by resident metrics, a matrix of potential contacts between individuals across regions can emphasize where potential contacts occur as nodes, or in the context of pandemic the regional infection risk as nodes, with network links being the weighted probability of contact between mobile devices 110 visiting or residing in a region respectively.

The following describes how the contact metric is computed mathematically. Suppose that for location point i for a mobile device 110, the triple (Xᵢ, Yᵢ, Rᵢ) where (Xᵢ, Yᵢ) is the reported location (in longitude and latitude) of the mobile device 110 and Rᵢ is the radius of horizontal uncertainty associated with a location of the mobile device 110. An assumption is made that the horizontal uncertainty radius Rᵢ is the (1−α)×100% quantile of the radial density of the device location. This distribution is specified as a symmetric bivariate Gaussian centered at the true device location (μₓ, μ_{y}) with covariance matrix σᵢ²I, where I is the 2×2 identity matrix. Then (Xᵢ, Yᵢ) has density

$$f ( x , y \vert {σ}_{i}^{2} ) = \frac{1}{2 {πσ}_{i}^{2}} exp [ - \frac{1}{2 {σ}_{i}^{2}} ( {( x - {μ}_{x} )}^{2} + {( y - {μ}_{y} )}^{2} ) ] .$$

If Rᵢ=rᵢ is the horizontal uncertainty associated with the (1−α)×100% quantile radial density level set of the point i, then rᵢ=σᵢΦ−1(1−α), where Φ−1(·) is the standard normal quantile function. An estimate the variance σᵢ² can be determined by

\hat{σ}ᵢ²=rᵢ²/(Φ⁻¹(1−α))². (1)

Herein, α=0.05, and the Euclidean distance between the reported location of two points (Xᵢ, Yᵢ, Rᵢ) and (Xⱼ, Yⱼ, Rⱼ) is

Dᵢⱼ=\sqrt{(Xᵢ−Xⱼ)²+(Yᵢ−Yⱼ)²}

with a fixed distance ϵ>0. As used herein, ϵ is equal to two meters, although other distances are possible. The probability that points i and j are within E meters of one another is evaluated. This probability can be expressed as

$$\begin{matrix}Pr ( {D}_{ij} \leq ϵ ) = Pr ( \sqrt{{( {X}_{i} - {X}_{j} )}^{2} + {( {Y}_{i} - {Y}_{j} )}^{2}} \leq ϵ ) \\ = Pr ( {( {X}_{i} - {X}_{j} )}^{2} + {( {Y}_{i} - {Y}_{j} )}^{2} \leq {ϵ}^{2} ) \\ = Pr ( \frac{{( {X}_{i} - {X}_{j} )}^{2} + {( {Y}_{i} - {Y}_{j} )}^{2}}{{σ}_{i}^{2} + {σ}_{j}^{2}} \leq \frac{{ϵ}^{2}}{{σ}_{i}^{2} + {σ}_{j}^{2}} )\end{matrix} . \qquad ( 2 )$$

Now under the assumption that (Xᵢ, Yᵢ) and (Xⱼ, Yⱼ) have independent bivariate Gaussian distribution, the variance-scaled quantity

$$\frac{{( {X}_{i} - {X}_{j} )}^{2} + {( {Y}_{i} - {Y}_{j} )}^{2}}{{σ}_{i}^{2} + {σ}_{j}^{2}} \qquad ( 3 )$$

follows the non-central chi-square distribution with 2 degrees of freedom and non-centrality parameter

$$\frac{{( {μ}_{xi} - {μ}_{xj} )}^{2} + {( {μ}_{yi} - {μ}_{yj} )}^{2}}{{σ}_{i}^{2} + {σ}_{j}^{2}} . \qquad ( 4 )$$

Since the true device locations and variances in (4) are not observed, the observed device locations Xᵢ, Yᵢ, Xᵢ, and Yⱼ is substituted, as well as the estimated variances \hat{σ}ᵢ² and \hat{σ}ⱼ² computed from (1). Because the variance-scaled squared distance (3) follows the non-central Chi-square distribution, the probability that the two mobile devices, such as mobile device 110a, 110b, are within two meters, Dᵢⱼ≤2, can be computed using standard statistical software.

In reality, the Earth is not a plane and the Euclidean distance Dᵢⱼ is shorter than the true distance between i and j on the surface of the Earth. But for distant points or those whose uncertainty radius is large, it is necessary to evaluate longer distances on the surface of the Earth. The Haversine distance is substituted for the Euclidean distance Dᵢⱼ in the calculation above. The resulting Gaussian approximation is useful for small geodesic distances because points that are less than two meters apart are of interest.

To describe computation of the contact rate, let Zᵢ(t)=(Xᵢ(t), Yᵢ(t), Rᵢ(t)) be the location and corresponding horizontal uncertainty radius for mobile device 110 i at timer. A potential contact between mobile devices 110 i and j at time t occurs when the locations of the two devices Zᵢ(t) and Zⱼ(t) are stationary and nearby. Let Dᵢⱼ(t) be the computed distance between the two points i and j. When a potential contact occurs between i and j at time t, let

Pᵢⱼ(t)=Pr(Dᵢⱼ(t)≤ϵ)

be the probability that these mobile devices 110 are within c meters of each other. Let A_{ad} be the set of pairs of mobile devices 110 for which a potential contact event occurred within area a on day d. For a potential contact between a pair {i,j}, let tᵢⱼ be the time of the potential contact. In area a on day d, the expected number of contacts is the sum of the probabilities of contact, across every potential contact event. Two contact rates can be computed for each area a and day d. First, contact probabilities are aggregated by the area in which the contact occurred. The contact rate by region of contact is

$${C}_{ad}^{loc} = {\sum }_{\{ i , j \} ∈ {A}_{ad}} {P}_{ij} ( {t}_{ij} ) . \qquad ( 5 )$$

Next, contacts are aggregated by the region (town) of the mobile device's 110 primary dwell location. Let A be the set of all regions and let h(j) be the primary dwell region of device j. The mobile device 110 home contact rate is

$${C}_{ad}^{home} = {\sum }_{b ∈ A} {\sum }_{\{ i , j \} ∈ {A}_{bd}} {P}_{ij} ( {t}_{ij} ) 𝟙 \{ h ( i ) = a or h ( j ) = a \} , \qquad ( 6 )$$

where the indicator function [symbol] {·} is 1 if its argument is true, and 0 otherwise.

In order to compare the contact rate described herein to other mobility, metrics, Connecticut mobility data was acquired from Google, Apple, Facebook, Descartes Labs, and Cuebiq. All metrics are normalized to a day-of-week baseline using data from January or February depending on availability and plot their percent change from baseline from February 2020 through January 2021.

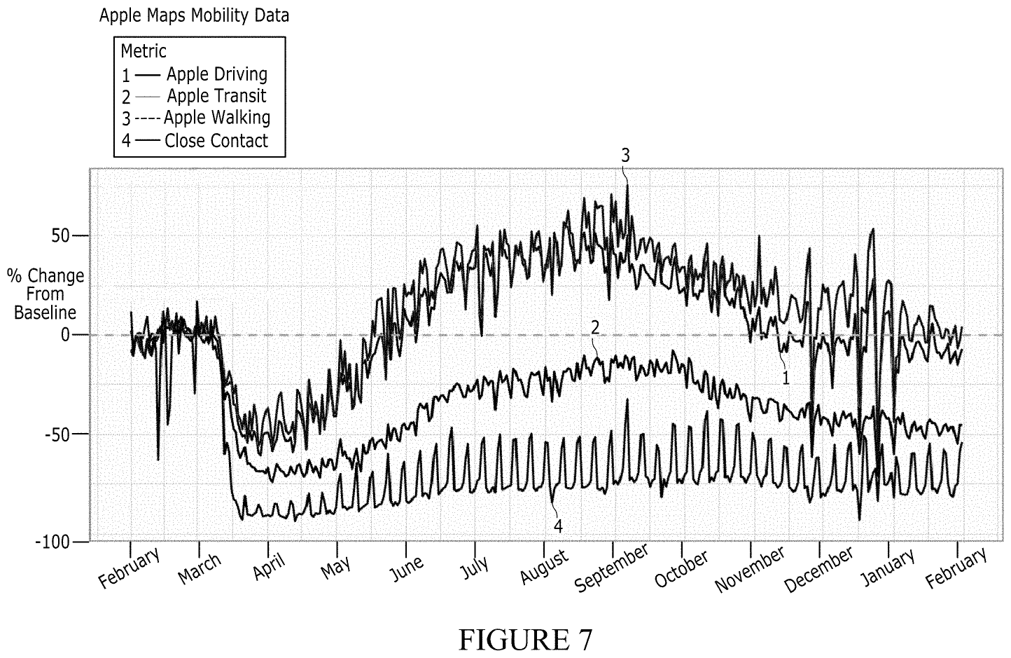

Apple state-level data measures Apple Maps routing requests, categorized as transit, walking, or driving. Map routing requests are a proxy for mobility but might not represent actual trips. Movements for which Apple Maps directions are not needed, such as everyday trips for work, school, or shopping, might not be represented in routing request metrics. FIG. 7 shows mobility metrics published by Apple using the day-of-week median during Feb. 2-Feb. 29, 2020 as a baseline. While transit use remained below baseline during March 2020 through January 2021, driving and walking returned to baseline in June 2020. Driving and walking remained above baseline until November 2020, at which point they returned to near baseline through January 2021. FIG. 7 shows a comparison of Apple Maps mobility metrics to the contact rate described herein during February 1-Jan. 31, 2021.

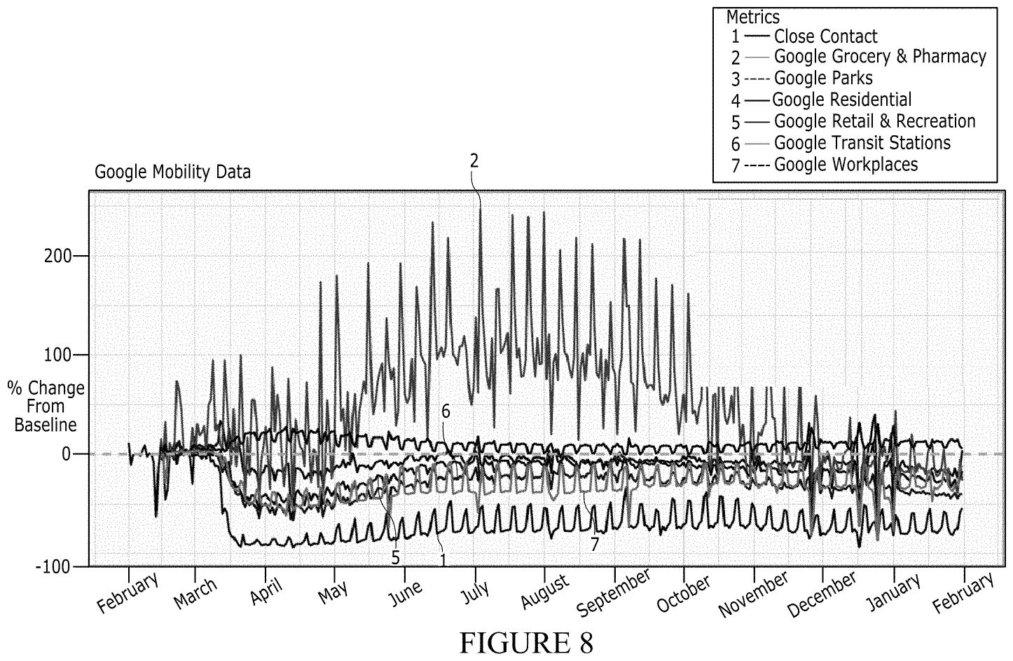

Google state-level mobility data measured visits to areas of interest, categorized as grocery and pharmacy, parks, residential, retail and recreation, transit stations, and workplaces. More detailed information about the definitions of these areas of interest, and the completeness of these categories, is not available. FIG. 8 shows mobility metrics published by Google using the day-of-week median from Jan. 3, 2020 to Feb. 6, 2020 as the baseline. All categories other than transit stations and workplaces returned to near baseline levels by summer 2020, and all categories other than residential remained near or below baseline throughout winter 2020. FIG. 8 shows a comparison of Google mobility metrics to the contact rate described herein during Feb. 1-Jan. 31, 2021.

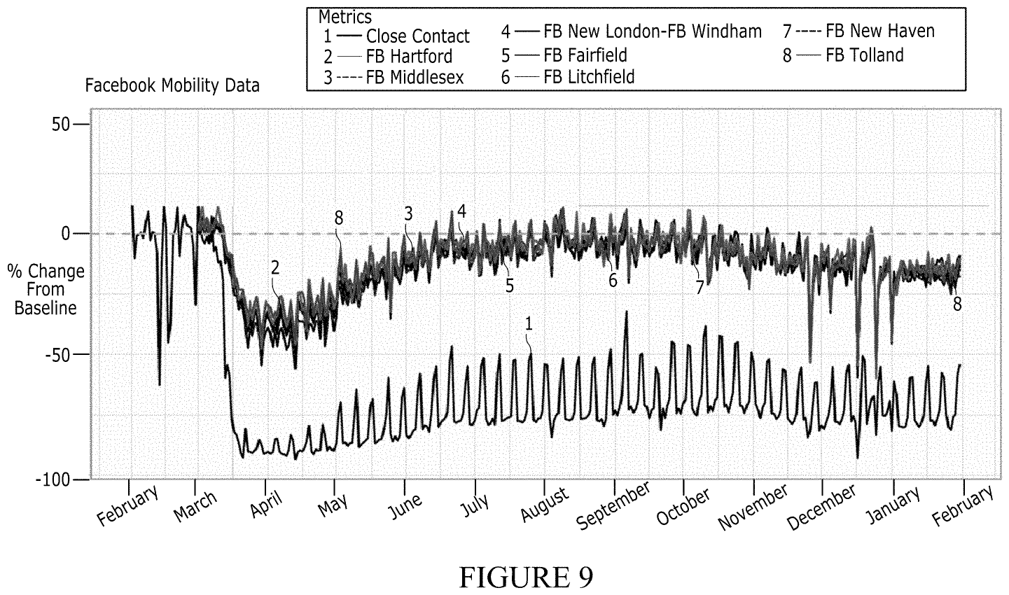

Facebook county-level mobility data measured the number of 600 m-by-600 m geographic units visited by a device in a day. This metric summarizes how mobile people from different counties are, but might not represent the distance of travel, time away from home, or potential close contacts with others. FIG. 9 shows mobility metrics published by Facebook with day-of-week mean during Feb. 2-Feb. 29, 2020 (excluding February 17) as the baseline. Facebook mobility levels returned to near baseline in all Connecticut counties by July 2020, with little difference between counties. From fall 2020 through January 2021, Facebook mobility levels for all counties decreased to slightly below baseline levels. FIG. 9 shows a comparison of Facebook (FB) mobility metrics to the contact rate described herein during Feb. 1-Jan. 31, 2021.

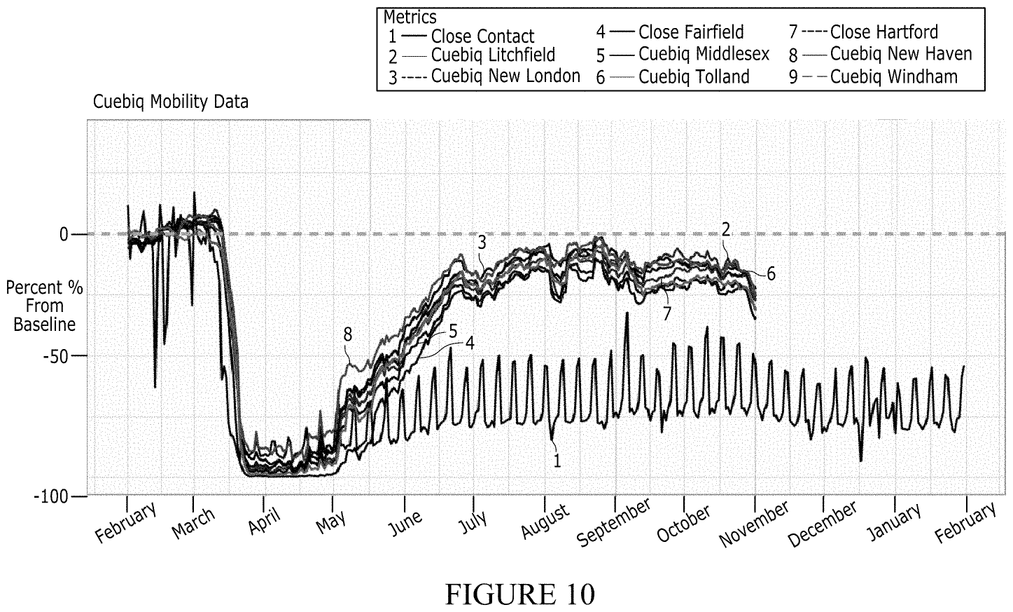

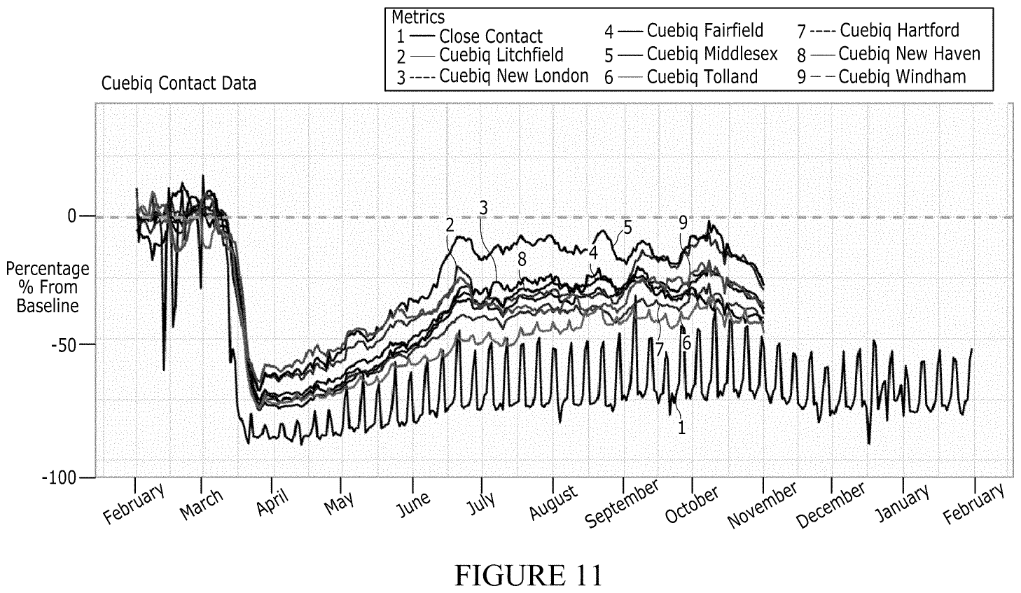

Cuebiq county-level mobility data measures a 7-day rolling average of the median distance traveled in a day, and was available through Nov. 1, 2020. FIG. 10 shows mobility data provided by Cuebiq with day-of-week median during Feb. 2-Feb. 29, 2020 as the baseline. By July 2020, Cuebiq mobility levels returned to near baseline. FIG. 10 shows a comparison of Cuebiq mobility metrics to the contact rate described herein during Feb. 1-Jan. 31, 2021. Cuebiq data available through Nov. 1, 2020. FIG. 11 shows Cuebiq's metric for “contact”, when two or more devices are within 50 feet of each other within five minutes. Information about whether this metric takes spatial error (horizontal uncertainty) into account is not available. In July 2020, Cuebiq contact levels remained further below baseline than the Cuebiq mobility metric. The Cuebiq 50-foot contact metric was closer to baseline than the calculated contact rate during summer and fall 2020. FIG. 11 shows a comparison of the 50-foot Cuebiq contact metric to the contact rate described herein during Feb. 1-Jan. 31, 2021. Cuebiq data available through Nov. 1, 2020.

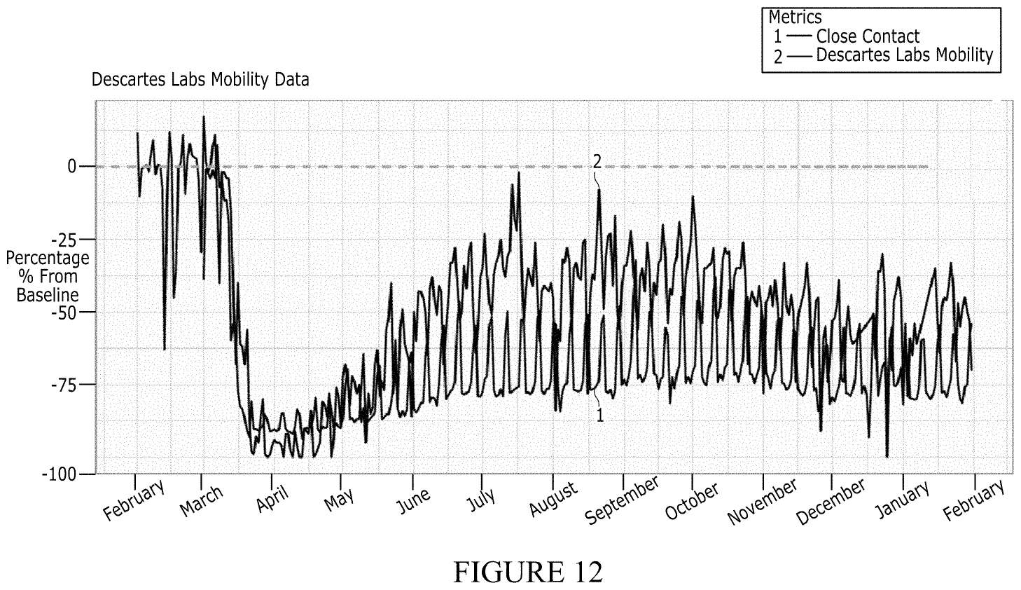

Finally, Descartes Labs state-level mobility data represents maximum distance devices have moved from the first reported location in a given day. FIG. 12 shows the mobility metric provided by Descartes Labs with day-of-week median during Feb. 17-Mar. 7, 2020 as the baseline. It was exceptional amongst the data sources in that mobility remained notably below baseline during March 2020-January 2021. However, the percent decline in close contact was consistently larger than the observed percent decline in the Descartes Labs mobility metric. FIG. 12 shows a comparison of Descartes Labs mobility metrics to the contact rate described herein during Feb. 1-Jan. 31, 2021.

In the context of determining COVID-19 spread discussed below, for every pair of devices, such as any pair of the mobile devices 110a-d, within each geographic region in a particular time interval, a determination is made of the probability that the pairs of mobile devices were within six feet of each other. These probabilities are all added, resulting in a “contact rate” or a rate of (close, as defined above) contact between pairs of mobile devices 110 per time interval within the geographic region. When the contact rate is higher, this means that devices are in contact more often in that geographic region.

Close contact between people is the primary route for transmission of SARS-CoV-2, the virus that causes coronavirus disease 2019 (COVID-19). As discussed above, the proximity detection application 150 quantifies interpersonal contact at the population-level by using anonymized mobile device geolocation data. The following example is taken from actual frequency of contact (within six feet) between people in Connecticut during February 2020-January 2021. Counts of contact events were aggregated by area of residence to obtain an estimate of the total intensity of interpersonal contact experienced by residents of each town for each day. In at least one configuration, the proximity detection application 150 can further include a pandemic prediction module 175, or any other module that can utilize the proximity date produced by the proximity detection application 150, that can receive the proximity data produced by the density of distance analyzer module 158 discussed above. In at least one other configuration, the pandemic prediction module 175 can be hosted on another device, e.g., computer, server, etc., that can receive the proximity data from the proximity detection apparatus 140. When incorporated into a susceptible-exposed-infective-removed (SEIR) model of COVID-19 transmission, the pandemic prediction module 175 can accurately predict contact rate for a pandemic, such as COVID-19 cases in Connecticut towns during the timespan, in accordance with the example provided herein. Although Connecticut is disclosed herein as an example in which COVID-19 prediction can be determined by the pandemic prediction module 175, one skilled in the art would understand that such is an example and that the pandemic prediction module 175 can predict pandemic spread in any area that has available mobility metrics.

The contact metric can be used to predict infections during a pandemic. Close contact between people is the primary route for transmission of the novel severe acute respiratory syndrome coronavirus 2 (SARS-CoV-2), the virus that causes coronavirus disease (COVID-19). Social distancing guidelines published by the United States (U.S.) Centers for Disease Control and Prevention (CDC) recommend that people stay at least six feet away from others to avoid transmission via direct contact or exposure to respiratory droplets. Throughout the world, non-pharmaceutical interventions, including social distancing guidelines and stay-at-home orders, have been employed to encourage the physical separation of people and reduce the risk of COVID-19 transmission via close contact. U.S. states with the lowest levels of self-reported social distancing behavior have experienced the most severe COVID-19 outbreaks.

The contact metric measures contact events, the primary behavioral risk factor for transmission, which can help explain historical patterns of transmission, assist policymakers in targeting interventions and messaging campaigns to encourage social distancing, guide public health response measures such as enhanced testing and contact tracing, and provide early warning to detect and prevent emerging outbreaks. By using highly detailed mobile device geolocation data for mobile devices 110 and the novel probabilistic method for assessing close proximity, as discussed above, total intensity of close interpersonal contact (within six feet) at the population-level (contact rate) is quantified and contact rate, as determined by the proximity detection application 150, can be used to explain patterns of COVID-19 incidence and predict emergence of new COVID-19 cases in the state of Connecticut, U.S. during Feb. 1, 2020-Jan. 31, 2021. Public health officials can then recommend implementing mitigating behavior(s) to address such patterns of COVID-19 incidence and predicted emergence of new COVID-19 within specific area(s) in which the patterns of COVID-19 incidence and predicted emergence of new COVID-19 are determined to be troublesome (e.g., beyond a pre-determined threshold), such mitigating behavior(s) can include mask-wearing, hand washing, avoidance of touching surfaces, avoidance of crowded indoor spaces, or any other mitigating behavior(s).

Anonymized location information was received, such as by the proximity detection application 150, for a sample of mobile devices 110 in Connecticut from X-Mode. From May 1, 2020 through Jan. 31, 2021, a total of 788,842 unique (anonymized) device IDs was observed, representing roughly 22% of the approximately 3.565 million residents of Connecticut (though some of those mobile devices 110 may have belonged to people residing elsewhere). An average of 141,617 unique mobile devices 110 were observed per day. For each week, an average of 80.5% of device IDs from the prior week were present in the data. Mobile devices 110 might not be present in the dataset if the user turns off their mobile device 110 or does not interact with applications that report location data. Using device geolocation records consisting of anonymized device IDs, GPS coordinates, date/time stamps, and GPS location error estimates (horizontal uncertainty), the location in which each mobile device 110 was calculated that had the most location records and designated that area as the mobile device's 110 primary dwell location (e.g., town of residence of device owner).

A contact event was computed, such as by the density of distance analyzer module 158, by using a probabilistic algorithm that computes the likelihood of simultaneous 2-meter proximity between pairs of mobile devices 110 across geographic areas. For each mobile device 110, sets of records were identified where mobile devices 110 were in spatial proximity to one another and stationary. A limitation of mobile device geolocation data is that it is not possible to precisely quantify the duration a mobile device 110 is stationary because device locations are collected asynchronously and irregularly over time. For each potential contact event, the probability was determined that locations of two mobile devices 110 are within six feet by assuming that the reported locations of the mobile devices 110 arise from a two-dimensional Gaussian probability distribution whose variance computed by using the horizontal uncertainty measure and correcting the distance to account for the curvature of the Earth.

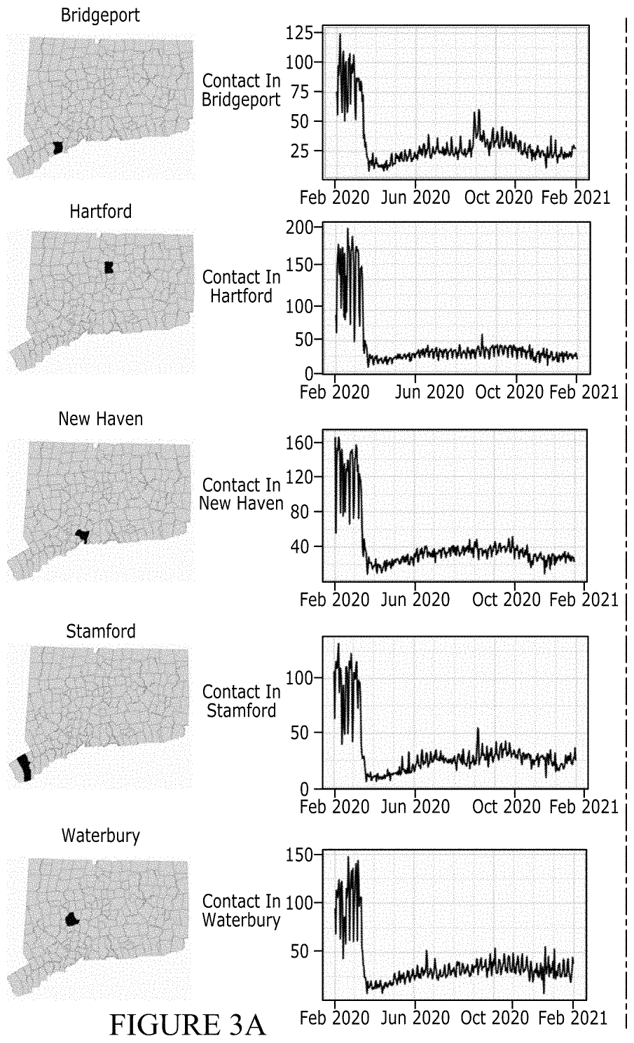

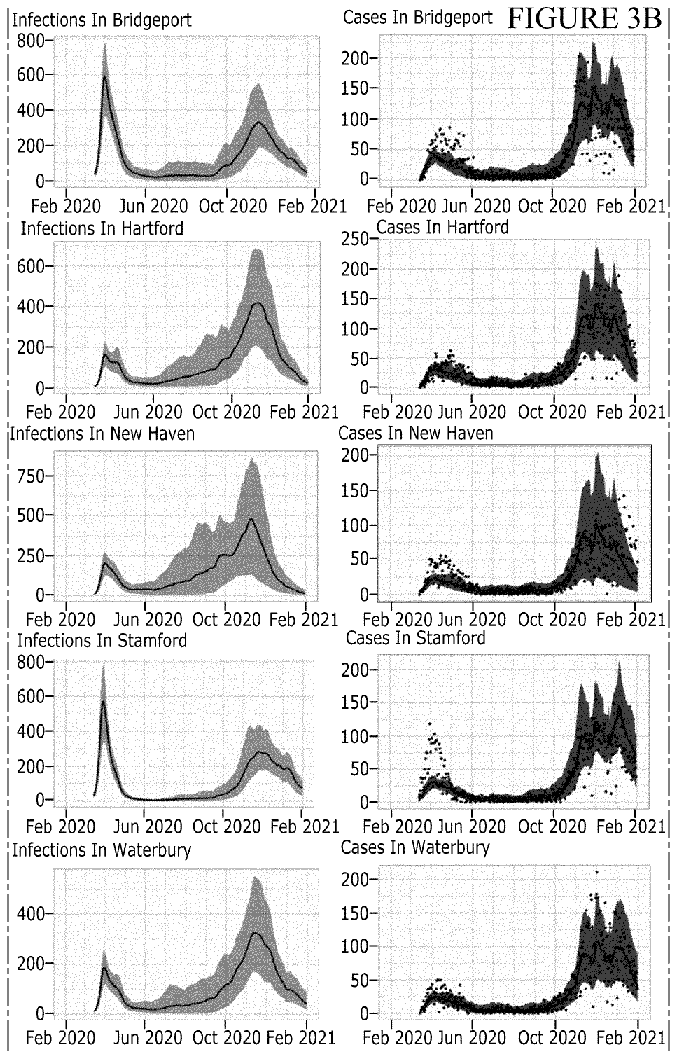

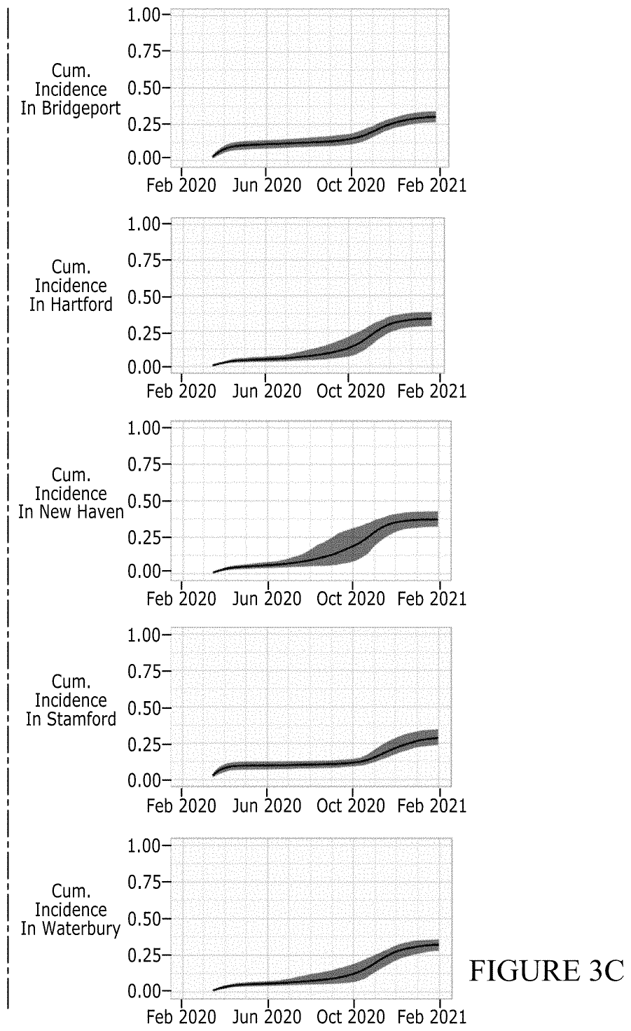

“Contact rate” is defined as the total number of contact events per day among observed mobile devices 110, such as at a town level; the pandemic prediction module 175 can determine the contact rate by summing daily contact probabilities for each mobile device 110 and assigning that sum to the device primary dwell location. Thus, although determination of contact rate is known, an improved determination of contact rate utilizing the system 110 including the proximity detection application 150, such as that shown in FIGS. 3-12 discussed below, provides for a novel contact rate determination, which in turn allows for improved recommendation(s) by public health officials for mitigating behavior(s), as discussed herein.

FIG. 3 shows the contact rate by town in Connecticut during Feb. 1-Jan. 31, 2021. At the top, maps show the number of contacts in Connecticut's 169 towns per day during weeks beginning on the first of each month. Darker regions indicate higher contact. At the bottom, statewide contact shows the daily frequency of close contact within six feet between distinct devices in the dataset. Connecticut Governor Ned Lamont's stay-at-home order and reopening phases 1, 2, 3, and 2.1 indicated. The state reverted to the more restrictive “Phase 2.1” in response to rising case counts in November. The state reverted to the more restrictive “Phase 2.1” in response to rising case counts in November.

Maps show the weekly average of daily contact rate by town, where darker colors in maps indicate a higher contact rate. The daily contact rate is shown in the plot shown in FIG. 3. The statewide contact rate dropped dramatically in March, about one week before Governor Lamont issued the statewide stay-at-home mandate on March 23. News of surging COVID-19 hospitalization and responses in the New York area, closure of public schools, and anticipation of a possible stay-at-home order might have played a role in reducing contact before the mandate was announced. After staying low during most of April, the contact rate began to rise slowly throughout the state during June-August. Incidence of infection was likely much higher during the first wave than the second, but steadily increasing availability of SARS-CoV-2 testing yielded higher case counts in the second wave.

Most mobility metrics provided by other companies returned to values near the February/March baseline by the beginning of July. In contrast, the contact rate shown in FIG. 3 shows that close interpersonal contact stayed low and rose slowly during June-August, 2020. Mobility metrics returned more quickly to the February 2020 baseline (or higher) compared to the contact rate and do not explain the low COVID-19 incidence achieved in Connecticut during June-August, 2020.

One explanation for the discrepancy between close contact and mobility metrics is that it is possible to travel far from home, to many distinct points of interest, or to many geographic areas, without coming into close contact with others. This might be what occurred in the summer of 2020: as Connecticut began its phased reopening plan, people resumed more normal patterns of away-from-home movement—work, shopping, or recreational activities—while maintaining social distancing. For this reason, when mobility metrics are used as proxy measures of close interpersonal contact, they may overstate the risk of disease transmission.

To evaluate the contact rate as a predictor of COVID-19 burden in Connecticut, confirmed COVID-19 case data was used from non-congregate settings reported to the Connecticut Department of Public Health. Cases were excluded among residents of long-term care facilities, managed residential communities (e.g., assisted living facilities), or correctional institutions. Non-congregate case data was aggregated by day of sample collection, by town. Town-level population estimates were obtained from the American Community Survey.

The pandemic prediction module 175 can predict transmission of SARS-CoV-2 and COVID-19 cases in a given area, with the example disclosed herein providing a prediction for Connecticut towns using a continuous-time deterministic compartmental transmission model based on the Susceptible-Exposed-Infective-Removed (SEIR) process. One skilled in the art would appreciate that the areas within Connecticut are but examples, and that the pandemic prediction module 175 can predict pandemic transmission for any area desired and not limited to the example disclosed. The pandemic prediction module 175 can accommodate for geographical variation in transmission within Connecticut and estimated features of COVID-19 disease progression, hospitalization, and death. This model incorporates flexible time-varying case-finding rates at the town level. The contact rate was incorporated into the time-varying transmission risk by multiplying the standardized contact rate by the product of the baseline transmission rate and the estimated number of susceptible and infectious individuals in each town. The pandemic prediction module 175 can fit the model to statewide data, and produce model projections for each of Connecticut's 169 towns using the town population size, time-varying contact rate, estimated initial infection fraction, and time-varying case-finding rate.

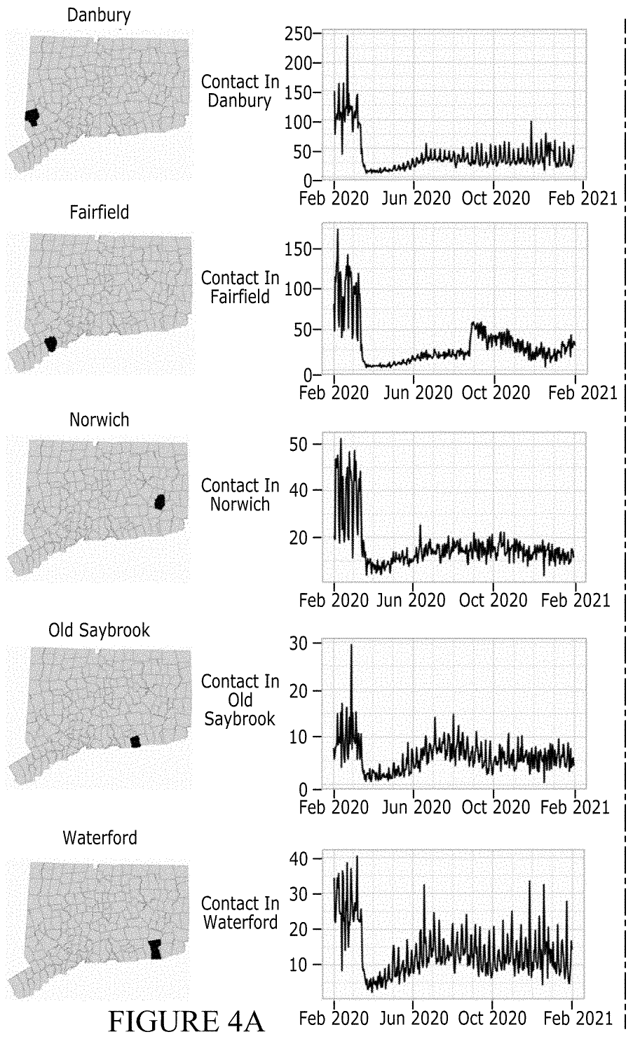

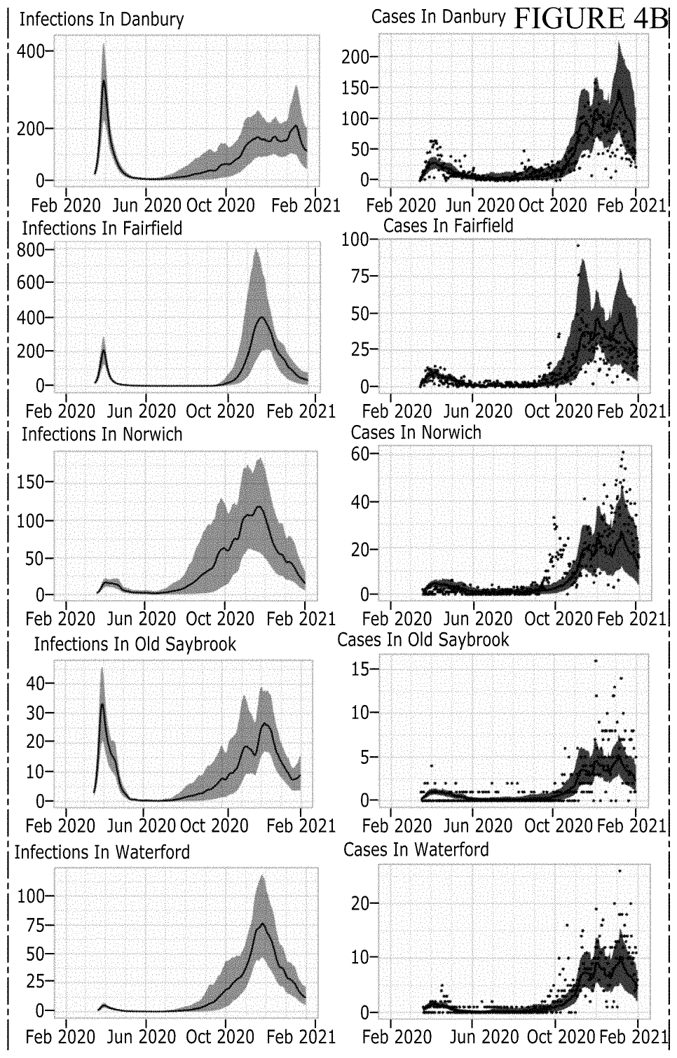

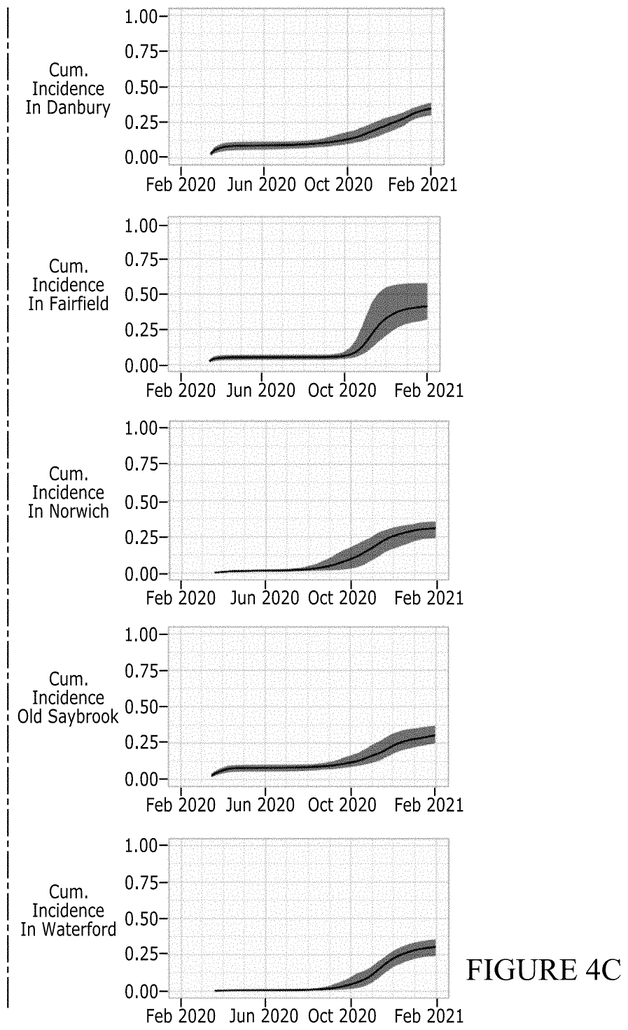

FIG. 4 shows contact rates, estimated SARS-CoV-2 infections, observed and estimated case counts, estimated cumulative incidence, as well as 95% uncertainty intervals for model estimates, for the five largest cities by population in Connecticut: Bridgeport, Hartford, New Haven, Stamford, and Waterbury. Contact rates in these towns largely mirror rates in the state as a whole. Model estimates track the pattern of case counts through the full course of the epidemic, including the dramatic reduction in transmission during June-August. In some towns, e.g., Stamford, case counts were under-estimated in model projections during the first wave during March-April 2020. In these cases, dynamics of SARS-CoV-2 infections may differ from the dynamics of case counts because the estimated case detection rate (via viral testing) varied dramatically over time and geography.

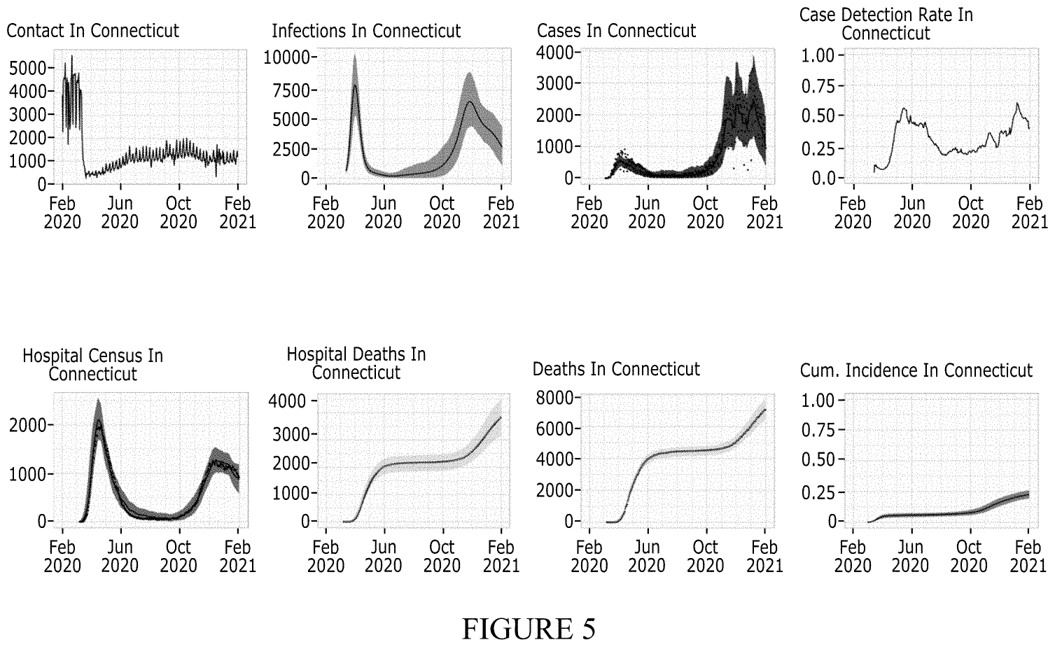

As COVID-19 case counts in Connecticut decreased during June-August, new and more heterogeneous patterns of transmission emerged. FIG. 5 shows contact rates, confirmed non-congregate COVID-19 case counts, and 95% uncertainty intervals for cases in five Connecticut towns where incidence patterns differed from those of the larger cities shown in FIG. 4.

During June-August, the only known community-wide COVID-19 outbreak in Connecticut occurred in the town of Danbury (population 84,479). During August 2-20, at least 178 new COVID-19 cases were reported, a significant increase from 40 cases reported during the prior week. Contact tracing investigations by public health officials attributed the outbreak to travel, but the contact rate was high in Danbury beginning in July and genomic analyses suggested the outbreak was closely linked to lineages already circulating in New York City and Connecticut. Predictions from the model including contact rates from Danbury suggest that this outbreak might have been part of a long-term increase in infections that began earlier in July and continued mostly unabated through November.

The town of Fairfield, bordering the larger city of Bridgeport, has a population of 62,105 people, and contains two universities, both of which reopened for in-person education in mid-August. The university communities experienced a surge in cases during September-October after students returned. Students had access to frequent COVID-19 testing, and test coverage in this community was likely higher than in the general population, so infections among students might have been more likely to be reported to public health authorities. Contact rates in both Fairfield and the adjacent city of Bridgeport increased (FIGS. 4 and 5) during September shortly after students arrived on campus. The consequence of this increase in contact rate is evident in the rise in case counts for Fairfield two to three weeks later.

The eastern part of Connecticut was largely spared in the first wave of infections during March-April, but Norwich (population 39,136) and nearby towns experienced a strong surge in cases beginning in mid-September. Contact rose more quickly in these towns, compared to the western part of the state, following the beginning of Phase 1 in May 2020. Low testing coverage during the spring and summer of 2020, imported infections from neighboring Rhode Island, and lower compliance with social distancing measures might have played a role in outbreaks in the eastern part of the state.

Contact data do not explain all variations in confirmed non-congregate COVID-19 case counts. Though the model fits cases well overall in large cities, it can fail to capture variation in case counts in smaller cities where testing coverage is lower, or in settings where case-finding effort varied over time. For example, high case counts corresponding to outbreak investigations involving extensive testing in Danbury during August, and Norwich during September/October, do not directly reflect changes in contact, and are not captured by the model projections.

Public health decision-makers track the COVID-19 pandemic using metrics—syndromic surveillance data, cases, hospitalizations, deaths—that lag disease transmission by days or weeks. As described herein, pandemic prediction module 175 can execute a novel method for population-level surveillance of close interpersonal contact, the primary route for person-to-person transmission of SARS-CoV-2, by using anonymized mobile device geolocation data. The contact rate can reveal high-contact conditions likely to spawn local outbreaks, or areas where residents experience high contact rates, days or weeks before the resulting cases are detected by public health authorities through testing, traditional case investigation, and contact tracing. Because mobile device geolocation data are passively collected, contact rates are invariant to allocation and availability of public health resources for case finding. For this reason, contact rates, as determined by the proximity detection application 150, could serve as a better early-warning signal for outbreaks than cases alone, especially when test volume is low. Contact rates could also have advantages over surveillance approaches using mobility metrics because interpersonal contact within six feet is more directly related to the likelihood of disease transmission by direct contact or respiratory droplets.

Contact rates could benefit public health efforts to prevent transmission of SARS-CoV-2 in two ways. First, community engagement programs could be directed to locations where the contact rate is high to improve social distancing practices or provide additional protective measures like ensuring adequate ventilation, environmental cleaning, and mask use. Second, enhanced testing in areas with high contact rates, and residential areas of people experiencing that contact, could lead to earlier and more complete detection of cases. Earlier and more complete detection of cases enables faster and more complete isolation of cases and quarantine of contacts, which are crucial to stop transmission and stop outbreaks.

Contact rates also may be a useful addition to mathematical models of infectious disease transmission for prediction of COVID-19 infections or cases. In the early stages of the COVID-19 pandemic, researchers employed variations on the classical SEIR epidemic model to predict the initial wave of infections, estimate parameters like the basic reproduction number, and assess the effect of non-pharmaceutical interventions. These models often assumed a constant population-level contact rate that is subsumed into a transmissibility parameter, or estimated contact rate from survey data collected prior to the pandemic.

The disclosed study focuses on the U.S. state of Connecticut, but the usefulness of anonymized and passively collected contact data could be generalized to other settings. In the U.S., where mobile device 110 usage is high, states or towns can implement contact surveillance at low cost by working with private sector mobile device 110 data providers. Like Connecticut, other states and countries experienced constrained testing availability in the early stages of the pandemic, and uneven geographic distribution of testing after test volume increased. Non-pharmaceutical interventions such as stay-at-home mandates, business and school closures, and social distancing guidelines also had uneven adoption and compliance varied across time and geography. Surveillance of contact rates could help officials better distribute testing resources and monitor intervention compliance in numerous settings. Internationally, mobile device 110 ownership has grown quickly but might be low in some developing countries, making contact surveillance less feasible in these settings.

The contact rate as determined by the proximity detection application 150, as described herein, has several advantages over existing mobility metrics and measures of mobile device density and proximity. First, the contact rate has been designed specifically to measure interpersonal contact within 6-feet relevant to COVID-19 transmission, as defined by CDC. In contrast, mobility metrics primarily measure movement, which might not be a good proxy measure of close interpersonal contact. For each potential contact event between two mobile devices 110, the proximity detection application 150 uses reported device locations and horizontal uncertainty measurements to determine the probability that the mobile devices 110 were within six feet of one another. In this way, each potential contact event is weighted by the likelihood that the people carrying the mobile devices 110 were close enough for transmission to occur. In contrast, Unacast's “human encounters” metric measures the frequency of two devices being within 50 meters of one another. Because the Unacast definition includes interactions that are at a distance much farther than six feet, many are unlikely to involve the potential for disease transmission. The contact rate disclosed herein incorporates close interpersonal contact, such as that occurring in every location in Connecticut, not only at pre-selected venues therefore, the contact rate might be a better proxy for population-level transmission risk when there are prevalent infections.

Statewide contact rate based on anonymized location information for mobile devices 110 helps explain Connecticut's success in avoiding a broad resurgence in COVID-19 cases during June-August 2020, emergence of localized outbreaks during late August-September, and a broad statewide resurgence during October-December. In addition to explaining historical patterns of transmission, incorporating the disclosed contact rates into an SEIR transmission model may improve prediction of future COVID-19 cases and outbreaks at the town level, which can inform targeted allocation of public health prevention measures, such as SARS-CoV-2 testing and contact tracing with subsequent isolation or quarantine. Contact rate estimated from anonymized location information, as disclosed herein, can help improve population-level surveillance of close interpersonal contact, guide public health messaging campaigns to encourage social distancing, and in allocation of testing resources to detect or prevent emerging local outbreaks.

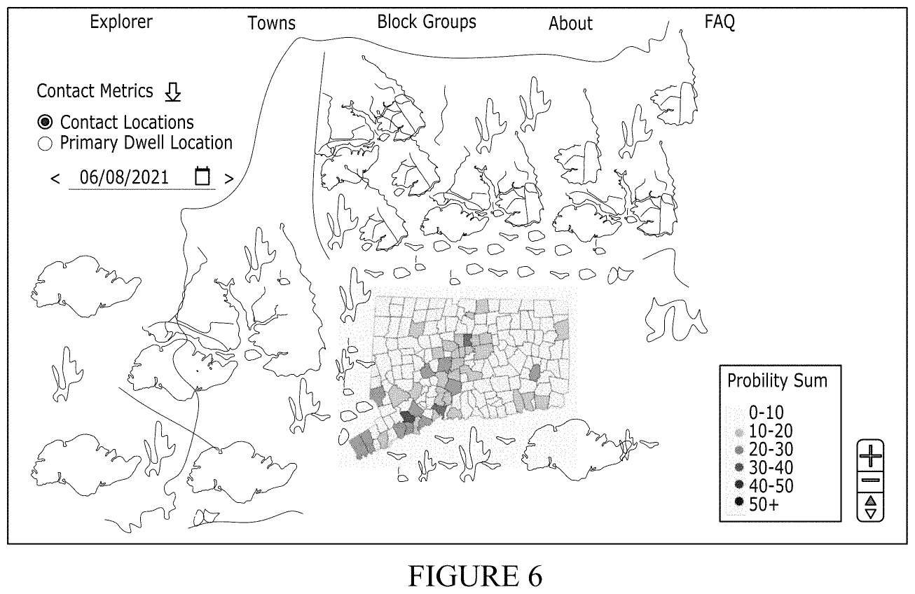

The pandemic prediction module 175 can include an interactive web application to allow users to explore contact patterns in Connecticut over time, available, e.g., at https://datapandemos.com/. FIG. 6 shows a screenshot that the interactive web application can display. The interactive web application shown in FIG. 6 shows contact in Connecticut towns on Dec. 6, 2020. The interactive web application can display the locations where contact is occurring or contact by the town of mobile device 110 primary dwell town. The interactive web application shows contact by location of contact (5) and by mobile device 110 primary dwell town 6 for each day, at the town and census block group levels. Users can view the contact maps over time from Feb. 1, 2020 to the present, as well as time trends of contact at the state and local levels. The interactive web application can show the top contact towns and census block groups throughout Connecticut, as well as points of interest—businesses, schools, hospitals—that help identify block groups.

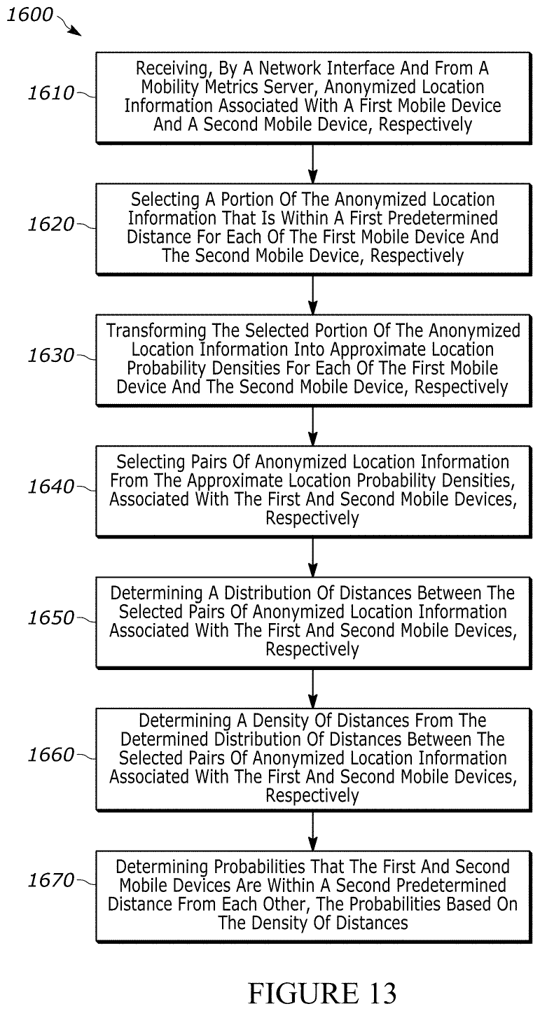

FIG. 13 shows a flowchart of a method 1600 of determining proximity data. Method 1600 can begin with a process 1610 that can receive, by a network interface (e.g., network interface 23700, discussed below) and from a mobility metrics server (e.g., mobility metrics server 130, discussed above), anonymized location information associated with the first mobile device and the second mobile device, respectively. In the example discussed above, the first and second mobile devices can be mobile devices 110a, 110b, although one skilled in the art would understand that the first and second mobile devices can be any two of the mobile devices 110a-d. Process 1610 can proceed to process 1620.

Process 1620 can select a portion of the anonymized location information that is within a first predetermined distance for each of the first mobile device and the second mobile device, respectively, from process 1610. As discussed above, this predetermined distance can be, in at least one configuration, can be approximately one (1) meter or three (3) feet, although other predetermined distances are possible, depending upon application of the method 1600 disclosed herein. In at least one configuration, the process 1620 can be performed by the anonymized location information analyzer module 152, discussed above. Process 1620 can proceed to process 1630.

Process 1630 can transform the selected portion of the anonymized location information into approximate location probability densities for each of the first mobile device and the second mobile device, respectively, from process 1620. In at least one configuration, the process 1630 can be performed by the location densities analyzer module 154, discussed above. Process 1630 can proceed to process 1640.

Process 1640 can select pairs of anonymized location information from the approximate location probability densities, associated with the first and second mobile devices, respectively. In at least one configuration, the process 1640 can be performed by the distribution of distances module 156, discussed above. Process 1640 can proceed to process 1650.

Process 1650 can determine a distribution of distances between the selected pairs of anonymized location information associated with the first and second mobile devices, respectively. In at least one configuration, the process 1650 can be performed by the distribution of distances module 156, discussed above. Process 1650 can proceed to process 1660.

Process 1660 can determine a density of distances from the determined distribution of distances between the selected pairs of anonymized location information associated with the first and second mobile devices, respectively. In at least one configuration, the process 1660 can be performed by the density of distance analyzer module 158, discussed above. Process 1660 can proceed to process 1670.

Process 1670 can determine probabilities that the first and second mobile devices are within a second predetermined distance from each other, the probabilities based on the density of distances. In at least one configuration, the process 1660 can be performed by the density of distance analyzer module 158, discussed above. In at least one configuration, process 1670 can proceed to processes described above that are performed by the pandemic prediction module 175, although in at least one other configuration process 1670 can proceed to other processes and/or modules, such as those described below.

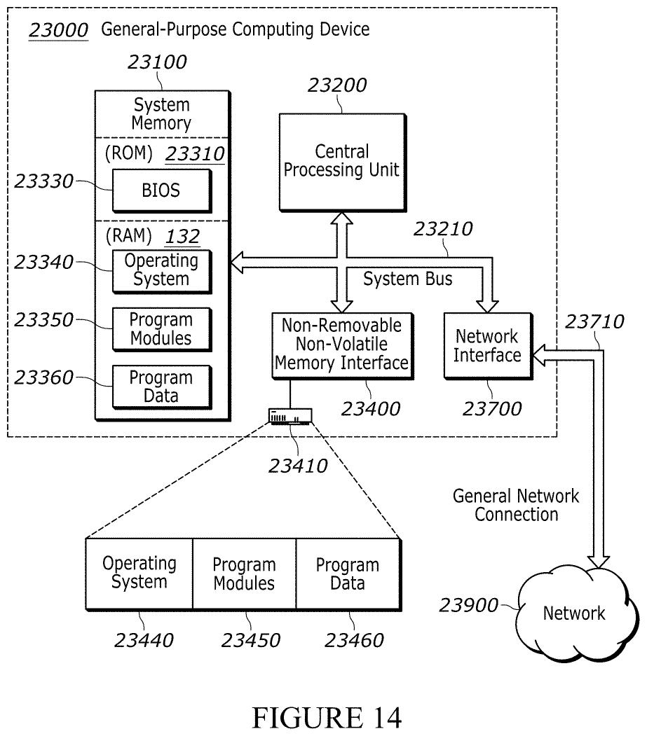

With reference to FIG. 14, an exemplary general-purpose computing device is illustrated in the form of the exemplary general-purpose computing device 23000. The general-purpose computing device 23000 may be of the type utilized for any of the plurality of mobile devices 110a-d, devices within the network 23900, the mobility metrics server 130, the proximity detection apparatus 140, and any other devices that these devices can communicate with (not shown). As such, it will be described with the understanding that variations can be made thereto. The exemplary general-purpose computing device 23000 can include, but is not limited to, one or more central processing units (CPUs) 23200, a system memory 23300, such as including a Read Only Memory (ROM) 23310 to store a Basic Input/Output System (BIOS) 23330 and a Random-Access Memory (RAM) 23320, and a system bus 23210 that couples various system components including the system memory to the processing unit 23200. The system bus 23210 may be any of several types of bus structures including a memory bus or memory controller, a peripheral bus, and a local bus using any of a variety of bus architectures. Depending on the specific physical implementation, one or more of the CPUs 23200, the system memory 23300 and other components of the general-purpose computing device 23000 can be physically co-located, such as on a single chip. In such a case, some or all of the system bus 23210 can be nothing more than communicational pathways within a single chip structure and its illustration in FIG. 14 can be nothing more than notational convenience for the purpose of illustration.

The general-purpose computing device 23000 also typically includes computer readable media, which can include any available media that can be accessed by computing device 23000. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 23000. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of any of the above should also be included within the scope of computer readable media.

When using communication media, the general-purpose computing device 23000 may operate in a networked environment via logical connections to one or more remote computers. The logical connection depicted in FIG. 14 is a general network connection 23710 to the network 23900, which can be a local area network (LAN), a wide area network (WAN) such as the Internet, or other networks. The computing device 23000 is connected to the general network connection 23710 through a network interface or adapter 23700 that is, in turn, connected to the system bus 23210. In a networked environment, program modules depicted relative to the general-purpose computing device 23000, or portions or peripherals thereof, may be stored in the memory of one or more other computing devices that are communicatively coupled to the general-purpose computing device 23000 through the general network connection 23710. It will be appreciated that the network connections shown are exemplary and other means of establishing a communications link between computing devices may be used.

The general-purpose computing device 23000 may also include other removable/non-removable, volatile/nonvolatile computer storage media. By way of example only, FIG. 14 illustrates a hard disk drive 23410 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 23410 is typically connected to the system bus 23210 through a non-removable memory interface such as interface 23400.

The drives and their associated computer storage media discussed above and illustrated in FIG. 14, provide storage of computer readable instructions, data structures, program modules and other data for the general-purpose computing device 23000. In FIG. 14, for example, hard disk drive 23410 is illustrated as storing operating system 23440, other program modules 23450, and program data 23460. Note that these components can either be the same as or different from operating system 23440, other program modules 23450 and program data 23460, stored in RAM 1320. Operating system 23440, other program modules 23450 and program data 23460 are given different numbers here to illustrate that, at a minimum, they are different copies.

With reference to FIGS. 1-14, again, the foregoing description applies to any of the plurality of mobile devices 110a-d, devices within the network 23900, the mobility metrics server 130, the proximity detection apparatus 140, and any other devices that these devices can communicate with (not shown). The network interface 23710 facilitates outside communication in the form of voice and/or data. For example, the communication module may include a connection to a Plain Old Telephone Service (POTS) line, or a Voice-over-Internet Protocol (VOIP) line for voice communication. In addition, the network interface 23710 may be configured to couple into an existing network, through wireless protocols (Bluetooth, 802.11a, ac, b, g, n, or the like) or through wired (Ethernet, or the like) connections, or through other more generic network connections. In still other configurations, a cellular link can be provided for both voice and data (i.e., GSM, CDMA or other, utilizing 2G, 3G, and/or 4G data structures and the like). The network interface 23710 is not limited to any particular protocol or type of communication. It is, however, preferred that the network interface 23710 be configured to transmit data bi-directionally, through at least one mode of communication. The more robust the structure of communication, the more manners in which to avoid a failure or a sabotage with respect to communication, such as to collect pandemic information in a timely manner.

The programming modules 23450 comprise a user interface which can configure the proximity detection application 150. In many instances, the programming modules 23450 comprises a keypad with a display that is connected through a wired connection with the processing unit 23200. Of course, with the different communication protocols associated with the network interface 23700, the network interface 23700 may comprise a mobile device that communicates with the network 23900 through a wireless communication protocol (i.e., Bluetooth, RF, WIFI, etc.). In other configurations, the programming modules 23450 may comprise a virtual programming module in the form of software that is on, for example, a smartphone, in communication with the network interface 23700. In still other configurations, such a virtual programming module may be located in the cloud (or web based), with access thereto through any number of different computing devices. Advantageously, with such a configuration, a user may be able to communicate with the proximity detection application 150 remotely, with the ability to change functionality.

One skilled in the art would understand that the pandemic prediction discussed above is but one use case for the determination of proximity between mobile devices 110 discussed above. The determination of proximity between mobile devices 110 determined by the proximity detection apparatus 140, and specifically the proximity detection application 150, can be utilized for other use cases, such as:

Construction of contact networks for infectious disease contact tracing. Close contacts between pairs of the mobile devices 110 can correspond to close contacts between people carrying those mobile devices 110. When one individual is found to be infected with an infectious disease, their contacts can be notified of a likely exposure. A contact network can be constructed in which the mobile devices 110 are nodes, and contact events are links between these nodes.

Law enforcement investigations of contacts of a person of interest. When the mobile device 110 is associated with a person of interest, law enforcement investigators may want to know which other mobile devices 110 the mobile device 110 of interest has been in contact with. The contact metric disclosed herein can provides an estimate of the probability of contact between the mobile devices 110. The people associated with these mobile devices 110 may be persons of interest in the investigation.

The contact metric disclosed herein can be applied to social advertising. Advertisers may wish to serve advertisements to the mobile devices 110 belonging to people who engage in close contact with one another. For example, advertisers could serve complementary messages to spouses or groups of friends or co-workers who are in frequent close contact.

The contact metric disclosed herein can be applied to social isolation and loneliness. The disclosed contact metric can be used to identify mobile devices 110 that rarely come into contact with other mobile devices 110, possibly indicating that the person associated with the mobile device 110 of interest is socially isolated and at risk of depression or other adverse social, health, or economic outcomes.

The contact metric disclosed herein can also be applied to social and political polarization. Mobile device 110 metadata can be associated with information on social stances or political affiliation. The contact metric disclosed can be used as a measure of contact within and between social or political affiliation groups.

The proximity detection performed by the proximity detection application 150 can be applied to even other use cases, such as physical security, risk analysis, threat intelligence, loss prevention, logistics management, infrastructure and economic development, transportation, marketing and advertising, tourism, environmental security, financial technology, and investment banking.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A method for determining a proximity between a first mobile device and a second mobile device, the method comprising:
receiving, by a network interface and from a mobility metrics server, anonymized location information associated with the first mobile device and the second mobile device, respectively;
selecting a portion of the anonymized location information that is within a first predetermined distance for each of the first mobile device and the second mobile device, respectively;
transforming the selected portion of the anonymized location information into approximate location probability densities for each of the first mobile device and the second mobile device, respectively;
selecting pairs of anonymized location information from the approximate location probability densities, associated with the first and second mobile devices, respectively;
determining a distribution of distances between the selected pairs of anonymized location information associated with the first and second mobile devices, respectively;
determining a density of distances from the determined distribution of distances between the selected pairs of anonymized location information associated with the first and second mobile devices, respectively; and
determining probabilities that the first and second mobile devices are within a second predetermined distance from each other, the probabilities based on the density of distances.

2. The method according to claim 1, the first predetermined distance is approximately one (1) meter or three (3) feet and the second predetermined distance is approximately two (2) meters or six (6) feet.

3. The method according to claim 1, the selecting selects the portion of the anonymized location information when the first and second mobile devices were stationary and within the predetermined distance to one another at a same time.

4. The method according to claim 1, further comprising excluding selection of the portion of the anonymized location information if the first and second mobile devices are within a buffered polygon.

5. The method according to claim 1, wherein the distribution of distances is determined analytically.

6. The method according to claim 1, further comprising performing a mathematical correction on the distances between the first and second mobile devices to account for a curvature of the Earth.

7. The method according to claim 1, further comprising adding the probabilities that the first and second mobile devices are within the second predetermined distance from each other to determine a rate of contact between the first and second mobile devices per a time interval within a region.

8. The method according to claim 1, further comprising predicting a pandemic spread based on the determined probabilities that the first and second mobile devices are within the second predetermined distance from each other.

9. The method according to claim 1, further comprising performing a Gaussian approximation for the distribution of distances between the selected pairs of anonymized location information associated with the first and second mobile devices.

10. The method according to claim 1, wherein the first and second mobile devices are at least one of a smartphone, a tablet computer, vehicle, an Internet-of-Things (IoT) device, and a smart watch.

11. An apparatus comprising:
a network interface to receive anonymized location information associated with the first mobile device and the second mobile device, respectively;
an anonymized location information analyzer module to select a portion of the anonymized location information that is within a first predetermined distance for each of the first mobile device and the second mobile device, respectively;
a location densities analyzer module to transform the selected portion of the anonymized location information into approximate location probability densities for each of the first mobile device and the second mobile device, respectively;
a distribution of distances module to select pairs of anonymized location information from the approximate location probability densities, associated with the first and second mobile devices, respectively, and determine a distribution of distances between the selected pairs of anonymized location information associated with the first and second mobile devices, respectively; and
a density of distance analyzer module to determine a density of distances from the determined distribution of distances between the selected pairs of anonymized location information associated with the first and second mobile devices, respectively, and determine probabilities that the first and second mobile devices are within a second predetermined distance from each other, the probabilities based on the density of distances.

12. The apparatus according to claim 11, the first predetermined distance is approximately one (1) meter or three (3) feet and the second predetermined distance is approximately two (2) meters or six (6) feet.

13. The apparatus according to claim 11, wherein the distribution of distances module selects the portion of the anonymized location information when the first and second mobile devices were stationary and within the predetermined distance to one another at a same time.

14. The apparatus according to claim 11, wherein the apparatus excludes selection of the portion of the anonymized location information if the first and second mobile devices are within a buffered polygon.

15. The apparatus according to claim 11, wherein the distribution of distances is determined analytically.

16. The apparatus according to claim 11, wherein the apparatus performs a mathematical correction on the distances between the first and second mobile devices to account for a curvature of the Earth.

17. The apparatus according to claim 11, wherein the apparatus further adds the probabilities that the first and second mobile devices are within the second predetermined distance from each other to determine a rate of contact between the first and second mobile devices per a time interval within a region.

18. The apparatus according to claim 11, further comprising a pandemic prediction module to predict a pandemic spread based on the determined probabilities that the first and second mobile devices are within the second predetermined distance from each other.

19. The apparatus according to claim 11, wherein the apparatus further performs a Gaussian approximation for the distribution of distances between the selected pairs of anonymized location information associated with the first and second mobile devices.

20. The apparatus according to claim 11, wherein the first and second mobile devices are at least one of a smartphone, a tablet computer, vehicle, an Internet-of-Things (IoT) device, and a smart watch.
